(19) United States
(12) Patent Application Publication
(10) Pub. No.: US 2025/0062624 A1
(43) Pub. Date: Feb. 20, 2025

(54) DISPATCH METHOD OF ENERGY MANAGEMENT SYSTEM FOR ENERGY STORAGE AND PHOTOVOLTAIC SYSTEM FOR INDUSTRIAL AND COMMERCIAL USE

(71) Applicant: Zhejiang Jinko Energy Storage Co., Ltd., Haining City (CN)

(72) Inventor: Junjie JIANG, Haining City (CN)

(21) Appl. No.: 18/939,496

(22) Filed: Nov. 6, 2024

(30) Foreign Application Priority Data
Jun. 19, 2024 (CN) 202410795987.4

(51) Int. Cl. H02J 3/38; H02J 3/32; H02J 3/46; H02J 7/00

(52) U.S. Cl. CPC H02J 3/381; H02J 3/32; H02J 3/466; H02J 7/0014; H02J 7/0034; H02J 7/00712; H02J 2203/10; H02J 2300/24

(57) ABSTRACT

The present disclosure provides a dispatch method of an energy management system for energy storage and a photovoltaic system for industrial and commercial use. The dispatch method includes: determining whether a third-party control system issues dispatch instructions, and initiating a third-party dispatching mode in response to determining that the third-party control system issues dispatch instructions; determining whether the cloud terminal issues dispatch curves, and initiating an active dispatching mode in response to determining that the cloud terminal issues dispatch curves; and initiating a passive dispatching mode in response to determining that the third-party control system does not issue any dispatch instruction and the cloud terminal does not issue any dispatch curve.

### CROSS REFERENCE TO RELATED APPLICATIONS

The present application claims the benefit of priority under the Paris Convention to Chinese Patent Application No. 202410795987.4, filed on Jun. 19, 2024, which is incorporated herein by reference in its entirety.

### TECHNICAL FIELD

Embodiments of the present disclosure relate to the technical field of energy storage and, more particularly, to a dispatch method of an energy management system for energy storage and a photovoltaic system for industrial and commercial use.

### BACKGROUND

With the unceasingly development of power systems, electrochemical energy storage systems, as an important part of energy storage technology, are widely used in the energy storage field. The electrochemical energy storage systems use electrochemical cells as energy storage elements, and the main function thereof includes storage, conversion and release of electrical energy. In the electrochemical energy storage systems, chemical reaction is used to store energy, electrical energy is converted into chemical energy, and chemical energy is then converted into electrical energy for output, achieving energy conversion through the charging and discharging between the positive and negative electrodes of the cells. The electrochemical energy storage systems can help the power system solve the problems caused by the fluctuation of new energy, improve the stability of the power grid, and provide the power grid with fast-response energy storage support during peaks in power usage. The electrochemical energy storage systems also serve as an important energy storage device in new energy, such as wind energy and solar energy, power generation systems, ensuring stable output of electrical energy. The electrochemical energy storage systems have a large scale and fast response speed, and can achieve the input and output of electrical energy within a specified range on a millisecond time scale. The electrochemical energy storage systems also have the advantage of precise control, i.e., they can stably output at any power point within an adjustable range. The electrochemical energy storage systems have the capacity of bidirectional adjustment, i.e., they can be electrical load when charging or power supply when discharging. However, in industrial and commercial scenarios, the demand for energy storage control is indeed complex and variable, and the achievement of economical and efficient energy management for electrochemical energy storage systems is essential for improving energy utilization efficiency, reducing costs and guaranteeing system stability.

### SUMMARY

In view of this, embodiments of the present disclosure provide a dispatch method of an energy management system for energy storage and a photovoltaic system for industrial and commercial use, for achieving the overall logic control of EMS strategy of electrochemical energy storage systems, and improving the economy and efficiency of power control for the industrial and commercial energy storage.

In one aspect, embodiments of the present disclosure provide a dispatch method of an energy management system for energy storage for industrial and commercial use, which is applied to an EMS system (Energy Management System for Energy Storage), a cloud terminal and a third-party control system. The EMS system is coupled to the cloud terminal and the third-party control system, respectively. In the dispatch method, it is determined whether the third-party control system issues dispatch instructions, and a third-party dispatching mode is initiated in response to determining that the third-party control system issues dispatch instructions, where in the third-party dispatching mode, the EMS system receives a dispatch instruction value of the third-party control system for distribution of energy storage power; it is determined whether the cloud terminal issues dispatch curves, and an active dispatching mode is initiated in response to determining that the cloud terminal issues dispatch curves, where in the active dispatching mode, the EMS system receives a dispatch curve issued by the cloud terminal and distributes the energy storage power according to the dispatch curve issued by the cloud terminal; and a passive dispatching mode is initiated in response to determining that the third-party control system does not issue any dispatch instruction and the cloud terminal does not issue any dispatch curve, where in the passive dispatching mode, the EMS system does not accept any dispatch curve issued by the cloud terminal, the EMS system runs a local control strategy, and distributes the energy storage power according to a planned dispatch curve in the EMS system.

In another aspect, embodiments of the present disclosure further provide a photovoltaic system for industrial and commercial use to which the above dispatch method is applicable. The photovoltaic system includes: an EMS system, a cloud terminal, a third-party control system, a power conversion system (PCS) and a photovoltaic controller, where the EMS system is coupled with the cloud terminal, the third-party control system, the power conversion system and the photovoltaic controller, respectively.

Compared with the prior art, the dispatch method of the energy management system for energy storage and the photovoltaic system for industrial and commercial use provided by the embodiments of the present disclosure at least achieve the following beneficial effects.

In the present disclosure, the third-party control system, the cloud terminal and the EMS system jointly constitute an efficient, safe and intelligent management system of a photovoltaic energy storage power station. The combined application of the mutually exclusive third-party dispatching mode, active dispatching mode and passive dispatching mode can adapt to the demands of different users in industrial and commercial scenarios. As an important supplement and extension of the EMS system, the third-party control system and the cloud terminal provide more functions and possibilities for the EMS system, so that the dispatch of the energy storage power is more intelligent, efficient and economical, achieving comprehensive monitoring, optimal dispatch and intelligent management of the photovoltaic energy storage power station, and improving the efficiency and reliability of photovoltaic power generation.

Any product implementing the present disclosure is not necessarily required to achieve all the technical effects described above at the same time.

Further features and advantages of the present disclosure will become clear through the following detailed description of exemplary embodiments of the present disclosure with reference to the accompanying drawings.

### BRIEF DESCRIPTION OF THE DRAWINGS

The accompanying drawings incorporated into the specification and forming part of the specification illustrate embodiments of the present disclosure and, together with their description, serve to explain the principles of the present disclosure.

FIG. 1 is a schematic structural view of a photovoltaic system for industrial and commercial use provided by the present disclosure;

FIG. 2 is a flowchart of a dispatch method of an energy management system for energy storage for industrial and commercial use provided by the present disclosure;

FIG. 3 is a flowchart of the dispatch method in a passive dispatching mode, provided by the present disclosure;

FIG. 4 is a flowchart of the dispatch method in an active dispatching mode, provided by the present disclosure;

FIG. 5 is a flow chart of the dispatch method in a third-party dispatching mode provided by the present disclosure;

FIG. 6 is a flowchart of the dispatch method in another passive dispatching mode, provided by the present disclosure;

FIG. 7 is a flowchart of the dispatch method in another active dispatching mode, provided by the present disclosure; and

FIG. 8 is a flowchart of the dispatch method in another third-party dispatching mode, provided by the present disclosure.

### DETAILED DESCRIPTION OF THE EMBODIMENTS

Various exemplary embodiments of the present disclosure will now be described in detail with reference to the accompanying drawings. It should be noted that, unless otherwise specified, the relative arrangement, numerical expressions and values of the components and steps illustrated in these embodiments do not limit the scope of the present disclosure.

The following description of at least one exemplary embodiment is in fact illustrative only and in no way imposes any limitation on the present disclosure and its application or use.

The techniques, methods and devices known to those of ordinary skill in the art may not be discussed in detail. However, where appropriate, these techniques, methods and devices shall be considered as part of the description.

In all the examples shown and discussed herein, any specific value shall be interpreted as merely exemplary rather than restrictive. Therefore, other examples of exemplary embodiments may have different values.

It should be noted that, similar reference numerals and letters denote similar elements in the following drawings, so once an element is defined in one drawing, it will not be further discussed in subsequent drawings.

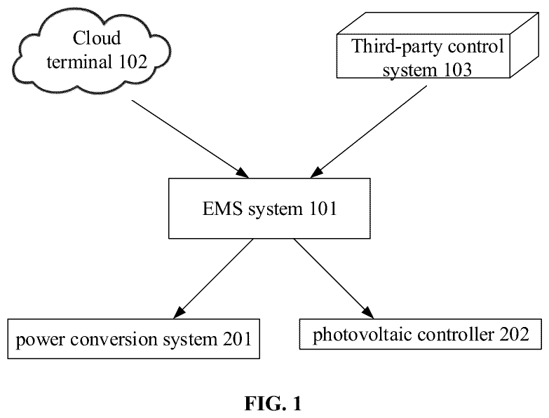

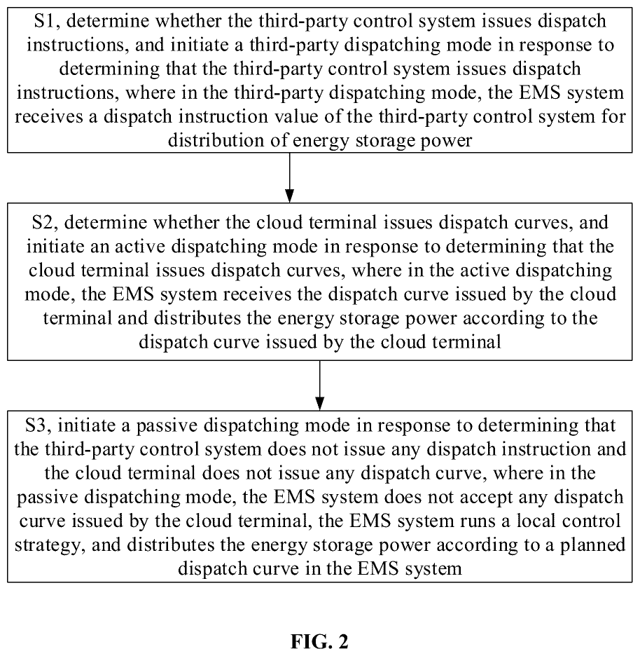

With reference to FIG. 1 and FIG. 2, FIG. 1 is a schematic structural view of a photovoltaic system for industrial and commercial use provided by the present disclosure, and FIG. 2 is a flowchart of a dispatch method of an energy management system for energy storage for industrial and commercial use provided by the present disclosure. The dispatch method of the energy management system for energy storage for industrial and commercial use of the present disclosure is applied to an EMS system 101, a cloud terminal 102 and a third-party control system 103, and the EMS system 101 is respectively coupled to the cloud terminal 102 and the third-party control system 103. The dispatch method includes the following operations S1 to S3.

In operation S1, it is determined whether the third-party control system issues dispatch instructions, and a third-party dispatching mode is initiated in response to determining that the third-party control system issues dispatch instructions, where in the third-party dispatching mode, the EMS system receives a dispatch instruction value of the third-party control system for distribution of energy storage power.

In operation S2, it is determined whether the cloud terminal issues dispatch curves, and an active dispatching mode is initiated in response to determining that the cloud terminal issues dispatch curves, where in the active dispatching mode, the EMS system receives a dispatch curve issued by the cloud terminal and distributes the energy storage power according to the dispatch curve issued by the cloud terminal.

In operation S3, a passive dispatching mode is initiated in response to determining that the third-party control system does not issue any dispatch instruction and the cloud terminal does not issue any dispatch curve, where in the passive dispatching mode, the EMS system does not accept any dispatch curve issued by the cloud terminal, runs a local control strategy, and distributes the energy storage power according to a planned dispatch curve in the EMS system.

The dispatch method of the energy management system for energy storage for industrial and commercial use of the present disclosure is applied to the EMS system, the cloud terminal and the third-party control system.

The EMS system, i.e., Energy Management System for Energy Storage, is a core management and control technology in an Energy Storage System (ESS). The EMS system is responsible for energy management and power management of the energy storage system to ensure safe and reliable operation of the energy storage system. The EMS system achieves control of charging and discharging, control of power output, distribution of energy and other functions of energy storage devices through intelligent control strategies to improve the efficiency and stability of the energy storage system.

As an auxiliary or supplement to the EMS system, the third-party control system can provide additional data acquisition and monitoring functions, i.e., it can acquire real-time data of a photovoltaic power station and the energy storage system through specific sensors and interfaces, and provide more comprehensive information support for the EMS system; the third-party control system can also achieve specific control logic, i.e., it can achieve specific control logic, such as automatic switching in the case of failure and emergency shutdown, in accordance with specific business requirements or safety specifications.

The cloud terminal can store and analyze data. The cloud terminal provides powerful data storage capacity, and can store massive data generated by the EMS system. At the same time, it can deeply mine the data through data analysis tools to provide data support for the optimization of the EMS system; the cloud terminal can also provide functions of remote monitoring and management, i.e., through a cloud platform, users can remotely access the EMS system to view the operating status and performance data of the photovoltaic power station and the energy storage system in real time, and users can further perform remote control operations, such as adjusting operating parameters, and starting/stopping the equipment; the cloud terminal can also provide intelligent decision support, i.e., in combination with big data, artificial intelligence and other technologies, the cloud terminal can provide intelligent decision support for the EMS system, for example, the cloud terminal can predict the photovoltaic power generation and the power grid demand in a future period of time according to the historical data and the real-time data, and provide suggestions for formulating a dispatch strategy of the EMS system.

The EMS system of the present disclosure is designed to have three dispatching modes, namely: third-party dispatching mode, active dispatching mode and passive dispatching mode.

In the third-party dispatching mode, the EMS system receives a value of a dispatch instruction or a schedule curve from the third-party control system, where the EMS system does not need to run any control strategy of its own, but only needs to operate according to the third party's instruction.

In the active dispatching mode, the EMS system receives a schedule curve for energy storage real power issued by the cloud terminal, adjusts a target value of the energy storage real power according to the schedule curve, and also uses active control strategies such as reverse flow prevention and demand control.

In the passive dispatching mode, the EMS system does not accept any schedule curve issued by the cloud terminal, but conducts active charge and discharge control on the energy storage according to strategies such as reverse flow prevention, time-of-use pricing, and demand control.

It should be noted that the third-party dispatching mode, the active dispatching mode and the passive dispatching mode in the present disclosure are mutually exclusive, which means that if the EMS system distributes the energy storage power according to the third-party dispatching mode, the EMS system no longer distributes the energy storage power according to the active dispatching mode or the passive dispatching mode; if the EMS system distributes the energy storage power according to the active dispatching mode, the EMS system no longer distributes the energy storage power according to the third-party dispatching mode or the passive dispatching mode; and if the EMS system distributes the energy storage power according to the passive dispatching mode, the EMS system no longer distributes the energy storage power according to the third-party dispatching mode or the active dispatching mode.

A control interface of the EMS system may be designed as follows: in the active dispatching mode, a web interface displays the planned dispatch curve issued by the cloud terminal, and the relevant active control strategies are also in operation; in the passive dispatching mode, the web interface displays a locally running schedule curve; and in the third-party dispatching mode, the web interface displays the planned dispatch curve issued by the third-party control system.

During the energy storage dispatching, operations S1 and S2 need to be performed. In operation S1, it is determined whether the third-party control system issues dispatch instructions, and the third-party dispatching mode is initiated in response to determining that the third-party control system issues dispatch instructions, where in the third-party dispatching mode, the EMS system receives a dispatch instruction value of the third-party control system for distribution of the energy storage power. In operation S2, it is determined whether the cloud terminal issues dispatch curves, and the active dispatching mode is initiated in response to determining that the cloud terminal issues dispatch curves, where in the active dispatching mode, the EMS system receives a dispatch curve issued by the cloud terminal and distributing the energy storage power according to the dispatch curve issued by the cloud terminal. The determination in the above operations S1 and S2 may be performed by the EMS system. In some embodiments, the EMS system includes a determination unit. In some other embodiments, the determination in the above operations S1 and S2 may be performed by an independent determination module, where the determination module is coupled with the EMS system and configured to send the determination result to the EMS system.

It should be noted that there is no necessary sequence between the operations S1 and S2, i.e., operation S1 may be performed prior to operation S2, and vice versa. As mentioned above, under general circumstances, the dispatch instruction issued by the third-party control system and the dispatch curve issued by the cloud terminal generally do not exist concurrently, and the third-party dispatching mode and the active dispatching mode are not performed concurrently either. If the EMS system distributes the energy storage power according to the third-party dispatching mode, the EMS system does not distribute the energy storage power according to the active dispatching mode. If the EMS system distributes the energy storage power according to the active dispatching mode, the EMS system does not distribute the energy storage power according to the third-party dispatching mode. In the case that the dispatch instruction issued by the third-party control system and the dispatch curve issued by the cloud terminal exist concurrently, a backstage manufacturer shall confirm the energy storage power should be distributed according to which instruction.

In the present disclosure, the third-party control system, the cloud terminal and the EMS system jointly constitute an efficient, safe and intelligent management system of a photovoltaic energy storage power station. The combined application of the mutually exclusive third-party dispatching mode, active dispatching mode and passive dispatching mode can adapt to the demands of different users in industrial and commercial scenarios. As an important supplement and extension of the EMS system, the third-party control system and the cloud terminal provide more functions and possibilities for the EMS system, so that the dispatch of the energy storage power is more intelligent, efficient and economical, achieving comprehensive monitoring, optimal dispatch and intelligent management of the photovoltaic energy storage power station, and improving the efficiency and reliability of photovoltaic power generation.

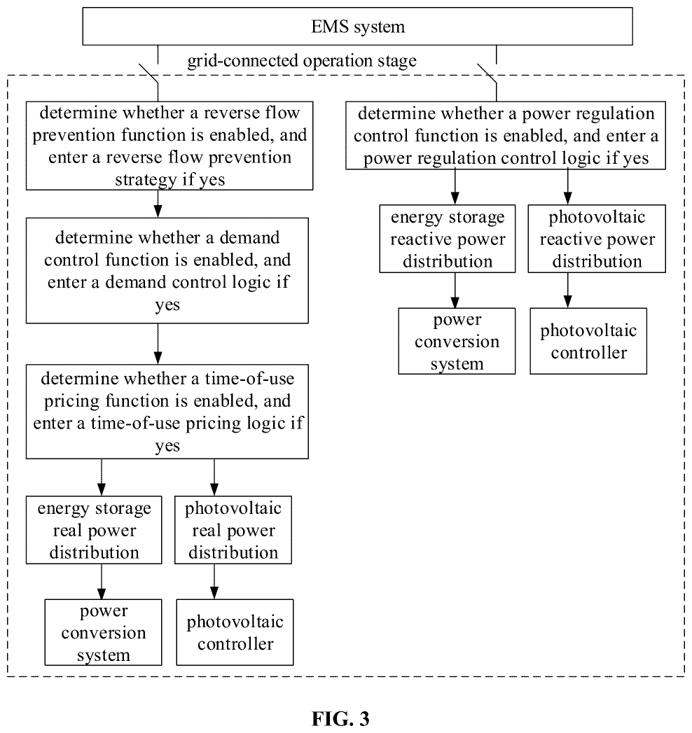

In some optional embodiments, with reference to FIG. 3, FIG. 3 is a flowchart of the dispatch method in the passive dispatching mode provided by the present disclosure, including a grid-connected operation stage. In this passive dispatching mode, it is determined whether a reverse flow prevention function is enabled, and a reverse flow prevention strategy is entered in response to determining that the reverse flow prevention function is enabled, and it is determined at the same time whether a power regulation control function is enabled, and a power regulation control logic is entered at the same time in response to determining that the power regulation control function is enabled; it is determined whether a demand control function is enabled, and a demand control logic is entered in response to determining that the demand control function is enabled; it is determined whether a time-of-use pricing function is enabled, and a time-of-use pricing logic is entered in response to determining that the time-of-use pricing function is enabled; and the EMS system outputs a real power target value and a reactive power target value, distributes the real power target value to the photovoltaic controller and the power conversion system, and distributes the reactive power target value to the power conversion system and the photovoltaic controller.

The reverse flow prevention refers to that, by monitoring the real power (P) and the reactive power (Q) of grid-connected points in real time, the EMS system maximizes, under the premise of meeting the requirements of equalization and protection of state of charge (SOC), the absorption of the power generated by the photovoltaic power station for energy storage charging when the grid-connected points are required to feed the grid with zero power or be connected to the grid at limited power but the photovoltaic power exceeds this value, and the EMS system limits the photovoltaic power when the energy storage system is fully charged, to finally meet the requirements of feeding the grid with zero power or being connected to the grid at limited power.

The power regulation control refers to power factor control, and the power regulation control aims to reduce the power regulation cost of the user. The electricity charge regulation rate can be queried in the national unified Power Regulation Charge Check Table. If the percentage obtained by looking up the table is negative, the user will be rewarded. Otherwise, the user will be fined.

Required quantity control aims to prevent the absorption power of Point of Common Coupling (PCC) or grid-connected point from exceeding a set maximum required quantity, i.e., control the real-time power not to exceed the preset allowable maximum required quantity according to the specified preset allowable maximum required quantity. By acquiring the power or required quantity of PCC or grid-connected point in real time, the real-time power is controlled not to exceed the preset allowable maximum required quantity through discharge of the energy storage and improvement of the photovoltaic output when the real-time power of grid-connected point exceeds the preset maximum required quantity.

The time-of-use pricing is based on the configured peak clipping and valley filling charging and discharging strategy, which enables the energy storage system to charge during off-peak hours with low price and discharge during peak hours with high price, effectively reducing the power consumption cost of load.

Power regulation control (i.e. power factor strategy) aims to control the reactive power only, and calculate the reactive power target value of grid-connected point according to the real power target value and the power factor target value of grid-connected point. The reactive power of energy storage is firstly regulated. If the requirement of reactive power of grid-connected point cannot be met within the adjustable range of reactive power of energy storage, the reactive power of a photovoltaic inverter is further regulated. If there is no photovoltaic inverter, the regulation is finished; and if the regulation of reactive power of energy storage plus photovoltaic still cannot reach the reactive power target value, the regulation is finished.

It is firstly determined whether the reverse flow prevention function is enabled, and the reverse flow prevention strategy is entered in response to determining that the reverse flow prevention function is enabled, and it is also determined at the same time whether the power regulation control function is enabled, and the power regulation control logic is entered at the same time in response to determining that the power regulation control function is enabled. It is then determined whether the demand control function is enabled, and the demand control logic is entered in response to determining that the demand control function is enabled. It is then determined whether the time-of-use pricing function is enabled, and the time-of-use pricing logic is entered in response to determining that the time-of-use pricing function is enabled. Southbound output (the subordinate devices or subordinate data flow relative to the EMS system) controls the real power target value or the reactive power target value. The real power target value is distributed to the photovoltaic controller and the power conversion system according to a multi-energy coordination strategy, and the reactive power target value is distributed to the energy storage, the photovoltaic or other reactive power compensation devices. The multi-energy coordination strategy refers to a unified control method for various energy forms such as photovoltaic power stations, wind farms and energy storage stations, and includes real power control strategy and reactive power control strategy.

It should be noted that the power conversion system is the key device between the energy storage device and the power grid, which is mainly used to connect the energy storage system and the power grid or load to realize the bidirectional conversion of electrical energy. In the grid-connected mode, the power conversion system can interact with the power grid to realize bidirectional flow of electrical energy. The photovoltaic controller may include photovoltaic power station inverter, photovoltaic power station data concentrator, photovoltaic irradiator, photovoltaic power station environmental detection equipment, etc. The photovoltaic controller is an indispensable important component in a photovoltaic power generation system. Through accurate control and management, the photovoltaic controller ensures efficient and stable operation of the photovoltaic system and provides strong guarantee for stability and reliability of the power system.

It can be understood that the EMS system may be equipped with an energy storage real power distribution module and a photovoltaic real power distribution module when the southbound output controls the real power target value. The real power target value is distributed to the power conversion system through the energy storage real power distribution module, and is also distributed to the photovoltaic controller through the photovoltaic real power distribution module. The EMS system may be equipped with an energy storage reactive power distribution module and a photovoltaic reactive power distribution module. The reactive power target value is distributed to the power conversion system through the energy storage reactive power distribution module, and is also distributed to the photovoltaic controller through the photovoltaic reactive power distribution module.

In the grid-connected operation stage of the passive dispatching mode provided by the present disclosure, in the grid-connected operation stage, the EMS system runs a local control strategy and performs power control according to its own schedule curve, which is also constrained by the demand control, the reverse flow prevention function, the time-of-use pricing and the power regulation control. Under the condition that the third-party control system does not issue any dispatch instruction and the cloud terminal does not issue any dispatch curve, the EMS system can perform power control self-adaptively, and adapt to the demands of different users in industrial and commercial scenarios.

In some optional embodiments, the power conversion system takes precedence over the photovoltaic controller when distributing the reactive power target value to the power conversion system and the photovoltaic controller.

It can be understood that the power conversion system can accurately control the reactive power outputted by itself and realize the real-time regulation of the reactive power of the power grid. The accurate control by the power conversion system can effectively balance the reactive power in the power grid and ensure the stability of the power grid voltage. In contrast, the photovoltaic controller mainly focuses on the maximum power point tracking (MPPT) and conversion of direct current to alternating current of the photovoltaic system, and has relatively weak regulation capability for reactive power.

Grid stability is an important consideration in a multi-energy coordinated power system. The power conversion system has fast response and regulation capability, which can quickly respond to the demand of the power grid for reactive power, provide necessary reactive power support for the power grid, and thus enhance the stability of the power grid. Although the photovoltaic controller can provide a certain quantity of reactive power, its response speed and regulation capacity are limited and insufficient to meet the real-time demand of the power grid for reactive power.

The energy storage system not only has the capacity of storing and releasing real power, but also can realize regulation of reactive power through the power conversion system. These functional characteristics enable the energy storage system to participate in the regulation and control of the power grid in a more comprehensive manner, and improve the stability and reliability of the power grid. The photovoltaic system mainly focuses on power generation and conversion of direct current to alternating current, and regulation of reactive power is not its primary function.

Therefore, when distributing the reactive power target value, considering the flexibility of regulation of reactive power, stability demand of the power grid, functional characteristics of the energy storage system, economic efficiency and technical development trend, etc., the power conversion system takes precedence over the photovoltaic controller, which helps to better utilize the advantages of the energy storage system and improve the stability and reliability of the power grid.

In some optional embodiments, the dispatch method in the passive dispatching mode provided by the present disclosure may further include an off-grid operation stage. In the passive dispatching mode, the energy storage system is switched to a virtual synchronous generator (VSG) mode, and a system control unit (SCU) of the energy storage system sets the real power target value of the power conversion system according to an off-grid SOC equalization strategy, where transient control is independently controlled by the power conversion system, and steady-state control is overall managed by the EMS system.

The VSG mode is the control strategy of a power electronic converter, in which the operating characteristics of a conventional synchronous generator are simulated, endowing the energy storage system with the ability to actively support the power grid. Passive regulation is changed to active support, so that the energy storage system can be more friendly connected to the power grid, improving the stability and operation efficiency of the power grid. VSG can operate in two modes: grid-connected and off-grid. During grid-connected operation, energy can flow bidirectionally and VSG can participate in power grid regulation; while during off-grid operation, VSG can supply power for its own load. In the present disclosure, the passive dispatching mode is switched to the VSG mode during off-grid operation, and the VSG mode allows the energy storage system to carry load independently, and provide voltage and frequency support.

The system control unit of the energy storage system sets the real power target value of the power conversion system according to the off-grid SOC equalization strategy. The SOC equalization control keeps the SOC consistent among the batteries by monitoring and adjusting the charge level in the batteries, so as to prolong the battery life and improve the efficiency of the energy storage system.

In the VSG mode, the transient control is mainly completed by the power conversion system itself. The transient control generally involves fast response to and adjustment of electrical parameters, such as the voltage and current, to ensure the stability and reliability of the system. The transient control is determined by the PCS, but the stable operation of the system requires the participation of the EMS. The dynamic balance of the photovoltaic, the energy storage and the load power is realized by controlling the power of the photovoltaic inverter. When the battery level is too low, the photovoltaic output needs to be increased to meet the load power and charge the battery; while when the battery level is too high, the photovoltaic output needs to be decreased to discharge the battery.

In the VSG mode, the steady-state control is overall managed by the EMS system. The EMS system can monitor the generation, storage and consumption of energy in the energy storage facilities in real time, and intelligently perform energy dispatch and control according to the real-time energy demand and system operation status. Through data analysis and optimization, the EMS system can provide optimization suggestions, such as adjusting charging and discharging strategies, and optimizing energy utilization efficiency.

In the case of off-grid operation, the passive dispatching mode is switched to the VSG mode. Combined with the SOC equalization strategy of the SCU and the overall management of the EMS system, it can be ensured that the energy storage system can operate efficiently and stably under the off-grid state and provide necessary support and regulation for the power system.

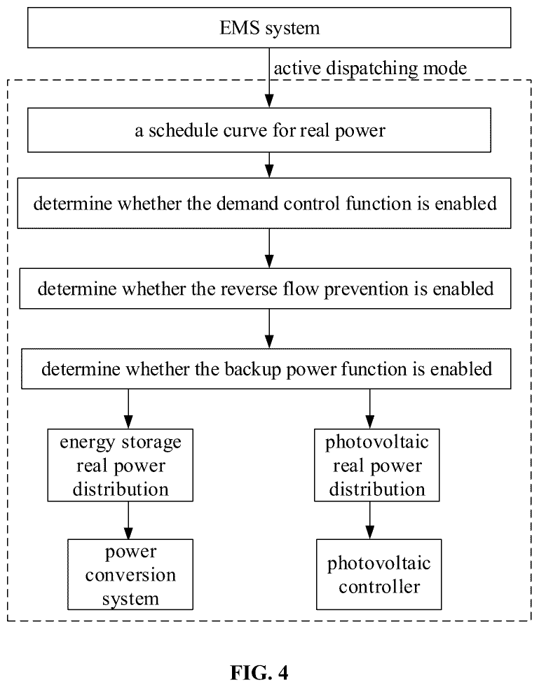

In some optional embodiments, with reference to FIG. 4, FIG. 4 is a flowchart of the dispatch method in the active dispatching mode provided by the present disclosure. In the active dispatching mode, the EMS system receives a schedule curve for real power issued by the cloud terminal; it is determined whether the reverse flow prevention function, the demand control function and the backup power function are enabled, and the real power target value is determined according to the schedule curve for real power based on a determination that the reverse flow prevention function, the demand control function, and the backup power function are not enabled; and the real power target value is distributed to the power conversion system, and the real power target value is distributed to the photovoltaic controller.

In some embodiments, the EMS system receives the schedule curve for real power issued by the cloud terminal and analyzes the received data to identify the key information in the schedule curve, such as charging and discharging time period and value of power. The EMS system formulates corresponding control strategies according to the received schedule curve for real power.

There is no necessary sequence between the above processes for determining the on-off state of the reverse flow prevention function, the demand control function, and the backup power function. FIG. 4 shows a sequence that the demand control function is first checked, then the reverse flow prevention function, and then the backup power function. It is also possible to first check the reverse flow prevention function, then the demand control function, and then the backup power function. It is also possible to first check the backup power function, then the reverse flow prevention function, and then the demand control function.

The reverse flow prevention refers to that, by monitoring the real power (P) and the reactive power (Q) of grid-connected points in real time, the EMS system maximizes, under the premise of meeting the requirements of equalization and protection of SOC, the absorption of the power generated by the photovoltaic power station for energy storage charging when the grid-connected points are required to feed the grid with zero power or be connected to the grid at limited power but the photovoltaic power exceeds this value, and the EMS system limits the photovoltaic power when the energy storage system is fully charged, to finally meet the requirements of feeding the grid with zero power or being connected to the grid at limited power.

Required quantity control aims to prevent the absorption power of Point of Common Coupling (PCC) or grid-connected point from exceeding a set maximum required quantity, i.e., control the real-time power not to exceed the preset allowable maximum required quantity according to the specified preset allowable maximum required quantity. By acquiring the power or required quantity of PCC or grid-connected point in real time, the real-time power is controlled not to exceed the preset allowable maximum required quantity through discharge of the energy storage and improvement of the photovoltaic output when the real-time power of grid-connected point exceeds the preset maximum required quantity.

For the backup power function, in some areas, primary and secondary protection shall be set for SOC of the energy storage system, so that the energy storage system can operate within the set SOC range when connected to the grid, and part of the electrical energy is reserved for backup power, which is used for power supply of load in the case of off-grid. The protection or restoration of SOC shall issue an alarm at each level.

In the active dispatching mode, the current status of the reverse flow prevention function, the demand control function and the backup power function are first queried through the user interface or API interface of the EMS system, and the status information may be displayed in binary form (such as 0 for off, 1 for on) or text form (such as “on” or “off”).

It is determined whether these three functions are enabled according to the status information queried. If these three functions are all disabled, the EMS system may directly determine the real power target value of the current period according to the schedule curve for real power issued by the cloud terminal. The schedule curve for real power generally contains the expected power output or input value in each time period, and the EMS system needs to resolve the curve data and extract the target value in the current time period. The real power target value may be a specific power value (e.g. 500 kW) or a power range (e.g. between 450 kW and 550 kW). Once the real power target value is determined, the EMS system can transmit this value to other components, i.e., the power conversion system and the photovoltaic controller, of the energy storage system through a communication interface (such as CAN bus and Modbus), to control the charging and discharging of the energy storage battery and make it meet the requirements of the schedule curve for real power.

In some optional embodiments, the photovoltaic system generates electricity at full power in the active dispatching mode.

On the one hand, under some industrial and commercial circumstances, such as remote areas with tight power supply or with energy self-sufficiency, full-power generation of the photovoltaic system can meet a larger energy demand and ensure the stability and reliability of power supply. On the other hand, the full-power generation of the photovoltaic system means that the system can maximize the conversion of solar energy into electrical energy under given conditions, which is conducive to improving energy utilization efficiency, reducing the cost of unit electrical energy and making photovoltaic power generation more economical.

It should be noted that the photovoltaic control system does not take restrictive measures. The EMS system plays a crucial role when the photovoltaic system generates electricity at full power in the active dispatching mode, because it needs to ensure stable operation of the system, and it may also need to coordinate the charging and discharging operations of other energy storage devices (such as battery energy storage system) to ensure stable operation of the system and optimize its performance.

In some optional embodiments, if it is determined that any one of the reverse flow prevention function, the demand control function, and the backup power function is enabled, the schedule curve for real power is exited, and the corresponding enabled function is implemented.

When the EMS system determines that any one of the reverse flow prevention function, the demand control function, and the backup power function is enabled, it no longer follows the schedule curve for real power to control the operation of the photovoltaic system and the energy storage system, but implements the specific enabled function, which means that the schedule curve for real power is temporarily suspended or overrode, and no longer serves as the main basis for the current control strategy.

If the reverse flow prevention function is enabled, the EMS system ensures that the power generated by the photovoltaic system does not flow reversely into the grid, which may involve adjusting the output power of the photovoltaic system or controlling the charging and discharging of the energy storage system.

If the demand control function is enabled, the EMS system limits the power transmitted by the photovoltaic system to the grid to ensure compliance with the demand limit agreed with the grid provider.

If the backup power function is enabled, the EMS system may manage the charging and discharging of the energy storage system to provide backup power when required.

The EMS system continuously monitors the status of the photovoltaic system, the energy storage system and the power grid when performing the enabled function. Based on the real-time data and system requirements, the EMS system adjusts its control strategy to ensure the stable operation of the system and meet the requirements of the enabled functions.

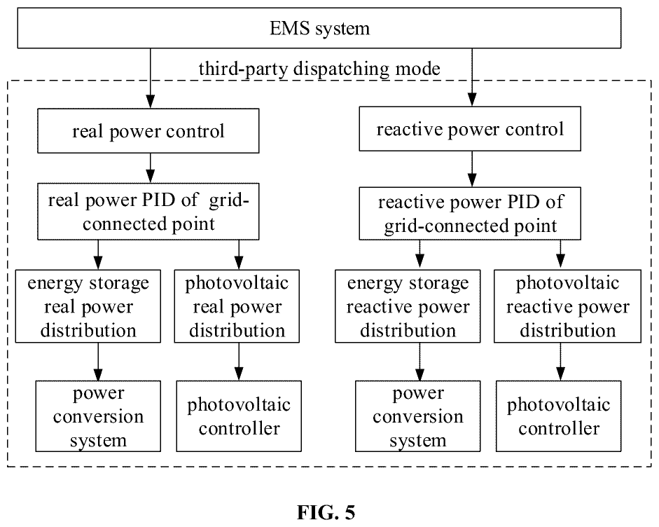

In some optional embodiments, with reference to FIG. 5, FIG. 5 is a flowchart of the dispatch method in the third-party dispatching mode provided by the present disclosure. In the third-party dispatching mode, the EMS system receives a third-party dispatch instruction value, where the third-party dispatch instruction value is divided into a real power control part and a reactive power control part. In the real power control part, power closed-loop is conducted through a real power proportional integral derivative (PID) controller of the grid-connected point; and the real power target value is distributed to the power conversion system, and the real power target value is distributed to the photovoltaic controller. In the reactive power control part, power closed-loop is conducted through a reactive power PID controller of the grid-connected point; and the reactive power target value is distributed to the power conversion system, and the reactive power target value is distributed to the photovoltaic controller.

Under the third-party dispatching mode, the EMS system directly receives the third-party dispatch instruction value. Under this mode, the control instruction is issued by the third-party control system, which can be divided into real power control and reactive power control according to the dispatch target. The real power control part firstly conducts closed-loop adjustment on the power through the PID of the grid-connected point to ensure power accuracy, and then carries out collaborative power distribution between the photovoltaic and the energy storage through multi-energy coordination. Finally, power distribution is carried out by the energy storage and photovoltaic inverter. The power distribution by the energy storage needs to consider SOC protection and equalization, while the power distribution by the photovoltaic inverter is based on photovoltaic power. The same applies to the reactive power control part.

When receiving the third-party dispatch instruction value, the EMS system carries out the real power control and the reactive power control respectively according to the instruction content. These two components cooperate with each other to jointly ensure the energy balance, stable operation and voltage quality of the power system.

The real power control part involves the process of converting electrical energy into other forms of energy (such as mechanical energy, optical energy, thermal energy, etc.). In the EMS system, it refers to realizing the predetermined real power output or input by adjusting and controlling the energy storage power station and the like. The objective of the real power control part is to reasonably organize and manage the energy storage power station and the like according to the third-party dispatch instruction value to provide or absorb the required real power, which is conducive to the energy balance and stable operation of the power system. For example, when the third-party dispatch instruction requires to increase the real power output of a certain area, the EMS system can meet this requirement by increasing the discharge power of the energy storage power station or adjusting the output of other power supply equipment.

The reactive power control part involves the energy required for maintaining the transformation between the electrical and magnetic fields in the circuit. In the EMS system, the predetermined reactive power output or absorption is realized by adjusting and controlling the energy storage power station and the like to ensure the voltage stability and power quality of the power system. The reactive power is adjusted according to the third-party dispatch instruction value. The EMS system can optimize the reactive power balance of the power system, reduce the reactive power loss and improve the voltage stability. For example, when the third-party dispatch instruction requires to improve the voltage quality of a certain area, the EMS system can optimize the voltage distribution of this area by adjusting the reactive power output or absorption of the energy storage power station, to improve the voltage stability. For the real power control part:

The real power PID controller of the grid-connected point is used to adjust and control the real power of the grid-connected point in real time, so as to ensure that the power output or input of the system matches the third-party dispatch instruction value.

By comparing the error between the actual power output and the set target value, the PID controller adjusts the control signal in real time to eliminate the error and reach the target value. This closed-loop control strategy can improve the response speed, stability and control accuracy of the system. The EMS system can more accurately control the real power output of the energy storage power station, the photovoltaic power station and the like through the power closed loop control of the real power PID controller of the grid-connected point, so as to meet the dispatching requirements of the power grid.

The EMS system calculates the real power target value of the power conversion system according to the third-party dispatch instruction value and the actual operation status of the system, and sends the target value to the power conversion system through the communication interface. The power conversion system automatically adjusts its output power according to the received real power target value to ensure that the energy output of the energy storage device matches the power grid demand.

The EMS system also calculates the real power target value of the photovoltaic controller according to the third-party dispatch instruction value and the actual status of the system, and sends the target value to the photovoltaic controller through the communication interface. The photovoltaic controller adjusts the working state of the solar cell array according to the received real power target value to maximize the utilization efficiency of solar energy and ensure that the output power of photovoltaic power generation meets the power grid demand.

The real power control part of the EMS system carries out the power closed-loop control through the real power PID controller of the grid-connected point, distributes the real power target value to the power conversion system and the photovoltaic controller, so as to realize the accurate control and management for the real power in the power system, which is conducive to improving the energy balance and stable operation level of the power system. For the reactive power control part:

The reactive power PID controller is used to adjust the reactive power output of the system to match the reactive power target value required by the system, compare the actual reactive power output with the set target value, and adjust the output of the system according to the difference to achieve the target value. This closed-loop control can ensure the fast response and accurate control of the system to the reactive power demand.

In the reactive power control, the power conversion system receives and responds to the reactive power target value according to the system demand. By adjusting the control parameters of the power conversion system, it outputs or absorbs a specific quantity of reactive power to support the stable operation and voltage regulation of the power grid.

By distributing the reactive power target value to the photovoltaic controller, it can adjust the reactive power output of the photovoltaic system, which is conducive to optimizing the grid-connected performance of the photovoltaic system, reducing the reactive power load of the power grid and improving the overall operation efficiency of the system.

The reactive power control part carries out the power closed-loop control through the reactive power PID controller of the grid-connected point, and distributes the reactive power target value to the power conversion system and the photovoltaic controller according to the system demand. This control strategy can ensure the stable operation of the power grid, optimize the grid-connected performance of renewable energy, and improve the overall operation efficiency of the system.

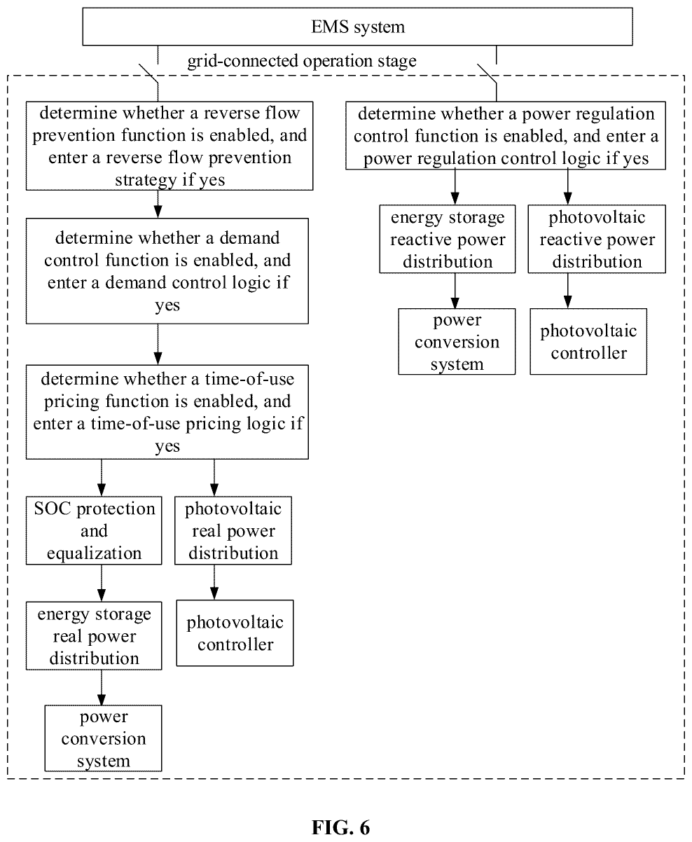

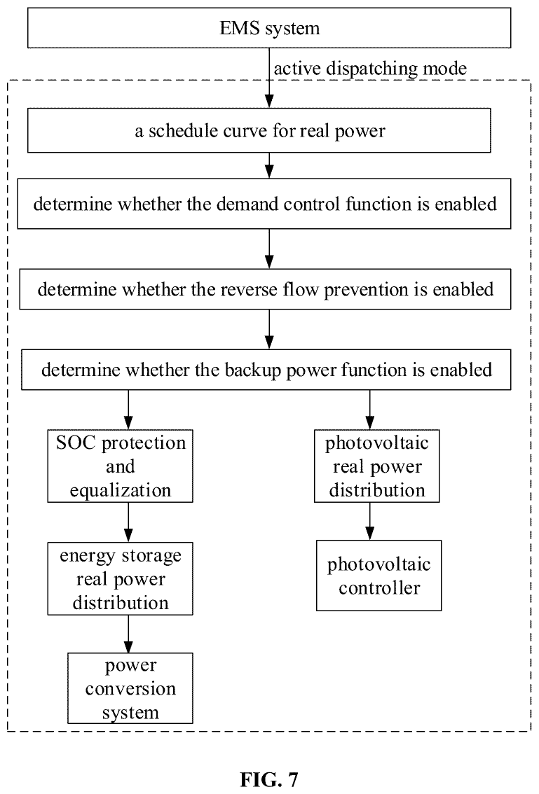

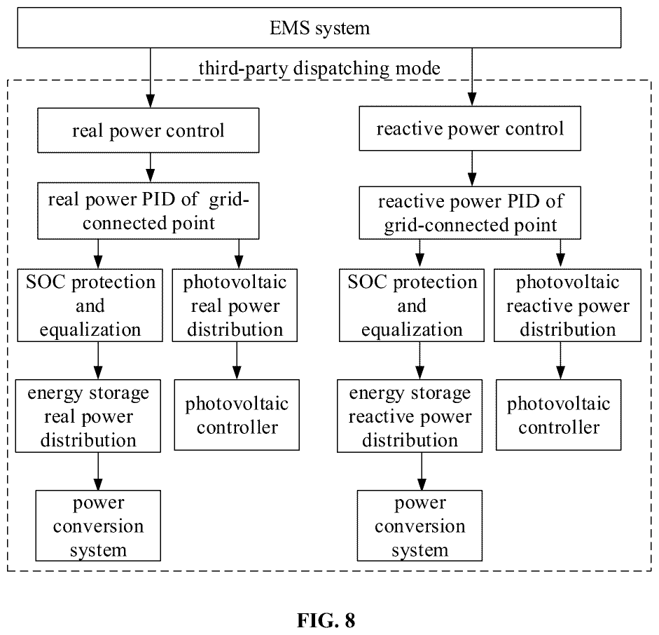

In some optional embodiments, referring to FIG. 6, FIG. 7 and FIG. 8, FIG. 6 is a flowchart of the dispatch method in another passive dispatching mode, provided by the present disclosure, FIG. 7 is a flowchart of the dispatch method in another active dispatching mode, provided by the present disclosure, and FIG. 8 is a flowchart of the dispatch method in another third-party dispatching mode, provided by the present disclosure. For the passive dispatching mode (as shown in FIG. 6), the active dispatching mode (as shown in FIG. 7) or third-party dispatching mode (as shown in FIG. 8), when the real power target value is distributed to the power conversion system, if there are plural power conversion systems, the state of charge equalization control scheme is activated.

In some embodiments, for the third-party dispatching mode, when the reactive power target value is distributed to the power conversion system, if there are plural power conversion systems, the state of charge equalization control scheme is activated.

Multiple power conversion systems correspond to multiple battery clusters, and each battery cluster has SOC. In order to ensure the optimal power storage of the whole power station, prevent the energy storage SOC from exceeding the upper and lower limits and balance, reduce battery loss, improve battery life, and maintain the energy storage battery in a healthy state, SOC equalization is required. According to the set upper and lower limits of the energy storage SOC, the management of charging and discharging of energy storage is optimized to ensure the efficient operation of each battery cluster. Otherwise, shortboard effect occurs, resulting in the decline of the charging and discharging efficiency of the whole battery.

On the basis of the same inventive concept, embodiments of the present disclosure further provide a photovoltaic system for industrial and commercial use to which the dispatch method of any one of the above embodiments is applicable. Further referring to FIG. 1, the photovoltaic system includes: an EMS system 101, a cloud terminal 102, a third-party control system 103, a power conversion system 201 and a photovoltaic controller 202, where the EMS system 101 is coupled with the cloud terminal 102, the third-party control system 103, the power conversion system 201 and the photovoltaic controller 202, respectively.

In the present disclosure, the third-party control system 103, the cloud terminal 102 and the EMS system 101 jointly constitute an efficient, safe and intelligent management system of a photovoltaic energy storage power station. The combined application of the mutually exclusive third-party dispatching mode, active dispatching mode and passive dispatching mode can adapt to the demands of different users in industrial and commercial scenarios. As an important supplement and extension of the EMS system 101, the third-party control system 103 and the cloud terminal 102 provide more functions and possibilities for the EMS system 101, so that the dispatch of the energy storage power is more intelligent, efficient and economical, achieving comprehensive monitoring, optimal dispatch and intelligent management of the photovoltaic energy storage power station, and improving the efficiency and reliability of photovoltaic power generation.

Though some specific embodiments of the present disclosure have been described in detail through examples, those skilled in the art should understand that the above examples are for illustrative purposes only and are not intended to limit the scope of the present disclosure. It should be understood by those skilled in the art that the above embodiments can be modified without departing from the scope and spirit of the present disclosure. The scope of the present disclosure is defined by the appended claims.

What is claimed is:

1. A dispatch method of an energy management system for energy storage (EMS) for industrial and commercial use, applied to an EMS system, a cloud terminal and a third-party control system, the EMS system being coupled to the cloud terminal and the third-party control system, respectively, the dispatch method comprising:
determining whether the third-party control system issues dispatch instructions, and initiating a third-party dispatching mode in response to determining that the third-party control system issues dispatch instructions, wherein in the third-party dispatching mode, the EMS system receives a dispatch instruction value of the third-party control system for distribution of energy storage power;
determining whether the cloud terminal issues dispatch curves, and initiating an active dispatching mode in response to determining that the cloud terminal issues dispatch curves, wherein in the active dispatching mode, the EMS system receives a dispatch curve issued by the cloud terminal and distributes the energy storage power according to the dispatch curve issued by the cloud terminal; and
initiating a passive dispatching mode in response to determining that the third-party control system does not issue any dispatch instruction and the cloud terminal does not issue any dispatch curve, wherein in the passive dispatching mode, the EMS system does not accept any dispatch curve issued by the cloud terminal, the EMS system runs a local control strategy, and distributes the energy storage power according to a planned dispatch curve in the EMS system.

2. The dispatch method of the EMS for industrial and commercial use according to claim 1, wherein the dispatch method in the passive dispatching mode comprises a grid-connected operation stage, and comprises:
determining whether a reverse flow prevention function is enabled, and entering a reverse flow prevention strategy in response to determining that the reverse flow prevention function is enabled, and determining at the same time whether a power regulation control function is enabled, and entering a power regulation control logic at the same time in response to determining that the power regulation control function is enabled;
determining whether a demand control function is enabled, and entering a demand control logic in response to determining that the demand control function is enabled;
determining whether a time-of-use pricing function is enabled, and entering a time-of-use pricing logic in response to determining that the time-of-use pricing function is enabled; and
outputting by the EMS system a real power target value and a reactive power target value, distributing the real power target value to a photovoltaic controller and a power conversion system, and distributing the reactive power target value to the power conversion system and the photovoltaic controller.

3. The dispatch method of the EMS for industrial and commercial use according to claim 2, wherein the power conversion system is prior to the photovoltaic controller in distributing the reactive power target value to the power conversion system and the photovoltaic controller.

4. The dispatch method of the EMS for industrial and commercial use according to claim 1, wherein the dispatch method in the passive dispatching mode comprises an off-grid operation stage, and comprises:
an energy storage system switching to a virtual synchronous generator (VSG) mode, and a system control unit (SCU) of the energy storage system setting a real power target value of the power conversion system according to an off-grid SOC equalization strategy, wherein transient control is independently controlled by the power conversion system, and steady-state control is overall managed by the EMS system.

5. The dispatch method of the EMS for industrial and commercial use according to claim 1, wherein the active dispatching mode comprises:
the EMS system receiving a schedule curve for real power issued by the cloud terminal;
determining whether a reverse flow prevention function, a demand control function and a backup power function are enabled, and determining the real power target value according to the schedule curve for real power based on a determination that the reverse flow prevention function, the demand control function, and the backup power function are not enabled; and
distributing the real power target value to a power conversion system, and distributing the real power target value to a photovoltaic controller.

6. The dispatch method of the EMS for industrial and commercial use according to claim 5, wherein the photovoltaic system generates electricity at full power in the active dispatching mode.

7. The dispatch method of the EMS for industrial and commercial use according to claim 5, wherein in response to determining that any one of the reverse flow prevention function, the demand control function, and the backup power function is enabled, the schedule curve for real power is exited, and the corresponding enabled function is implemented.

8. The dispatch method of the EMS for industrial and commercial use according to claim 1, wherein the third-party dispatching mode comprises:
the EMS system receiving a third-party dispatch instruction value, wherein the third-party dispatch instruction value is divided into a real power control part and a reactive power control part, wherein
the real power control part comprises:
conducting power closed-loop through a real power proportional integral derivative (PID) controller of a grid-connected point; and
distributing the real power target value to a power conversion system, and distributing the real power target value to a photovoltaic controller;
the reactive power control part comprises:
conducting power closed-loop through a reactive power PID controller of the grid-connected point; and
distributing the reactive power target value to the power conversion system, and
distributing the reactive power target value to the photovoltaic controller.

9. The dispatch method of the EMS for industrial and commercial use according to claim 2, wherein in distributing the real power target value to the power conversion system, in the case of a plurality of power conversion systems, a state of charge equalization control scheme is activated.

10. The dispatch method of the EMS for industrial and commercial use according to claim 5, wherein in distributing the real power target value to the power conversion system, in the case of a plurality of power conversion systems, a state of charge equalization control scheme is activated.

11. The dispatch method of the EMS for industrial and commercial use according to claim 8, wherein in distributing the real power target value to the power conversion system, in the case of a plurality of power conversion systems, a state of charge equalization control scheme is activated.

12. A photovoltaic system for industrial and commercial use, to which the dispatch method according to claim 1 is applicable, comprising: an EMS system, a cloud terminal, a third-party control system, a power conversion system and a photovoltaic controller, wherein the EMS system is coupled with the cloud terminal, the third-party control system, the power conversion system and the photovoltaic controller, respectively,
in a case that the third-party control system issues dispatch instructions, a third-party dispatching mode is initiated for the EMS system, wherein, in the third-party dispatching mode, the EMS system receives a dispatch instruction value of the third-party control system for distribution of energy storage power;
in a case that the cloud terminal issues dispatch curves, an active dispatching mode is initiated for the EMS system, wherein, in the active dispatching mode, the EMS system receives a dispatch curve issued by the cloud terminal and distributes the energy storage power according to the dispatch curve issued by the cloud terminal; and
in a case that the third-party control system does not issue any dispatch instruction and the cloud terminal does not issue any dispatch curve, a passive dispatching mode is initiated for the EMS system, wherein, in the passive dispatching mode, the EMS system does not accept any dispatch curve issued by the cloud terminal, runs a local control strategy, and distributes the energy storage power according to a planned dispatch curve in the EMS system.

13. The photovoltaic system for industrial and commercial use according to claim 12, wherein the dispatch method in the passive dispatching mode comprises a grid-connected operation stage, and comprises:
determining whether a reverse flow prevention function is enabled, and entering a reverse flow prevention strategy in response to determining that the reverse flow prevention function is enabled, and determining at the same time whether a power regulation control function is enabled, and entering a power regulation control logic at the same time in response to determining that the power regulation control function is enabled;
determining whether a demand control function is enabled, and entering a demand control logic in response to determining that the demand control function is enabled;
determining whether a time-of-use pricing function is enabled, and entering a time-of-use pricing logic in response to determining that the time-of-use pricing function is enabled; and
outputting by the EMS system a real power target value and a reactive power target value, distributing the real power target value to a photovoltaic controller and a power conversion system, and distributing the reactive power target value to the power conversion system and the photovoltaic controller.

14. The photovoltaic system for industrial and commercial use according to claim 13, wherein the power conversion system is prior to the photovoltaic controller in distributing the reactive power target value to the power conversion system and the photovoltaic controller.

15. The photovoltaic system for industrial and commercial use according to claim 12, wherein the dispatch method in the passive dispatching mode comprises an off-grid operation stage, and comprises:
an energy storage system switching to a virtual synchronous generator (VSG) mode, and a system control unit (SCU) of the energy storage system setting a real power target value of the power conversion system according to an off-grid SOC equalization strategy, wherein transient control is independently controlled by the power conversion system, and steady-state control is overall managed by the EMS system.

16. The photovoltaic system for industrial and commercial use according to claim 12, wherein the active dispatching mode comprises:
the EMS system receiving a schedule curve for real power issued by the cloud terminal;
determining whether a reverse flow prevention function, a demand control function and a backup power function are enabled, and determining the real power target value according to the schedule curve for real power based on a determination that the reverse flow prevention function, the demand control function, and the backup power function are not enabled; and
distributing the real power target value to a power conversion system, and distributing the real power target value to a photovoltaic controller.

17. The photovoltaic system for industrial and commercial use according to claim 16, wherein the photovoltaic system generates electricity at full power in the active dispatching mode.

18. The photovoltaic system for industrial and commercial use according to claim 16, wherein in response to determining that any one of the reverse flow prevention function, the demand control function, and the backup power function is enabled, the schedule curve for real power is exited, and the corresponding enabled function is implemented.

19. The photovoltaic system for industrial and commercial use according to claim 12, wherein the third-party dispatching mode comprises:
the EMS system receiving a third-party dispatch instruction value, wherein the third-party dispatch instruction value is divided into a real power control part and a reactive power control part, wherein
the real power control part comprises:
conducting power closed-loop through a real power proportional integral derivative (PID) controller of a grid-connected point; and
distributing the real power target value to a power conversion system, and distributing the real power target value to a photovoltaic controller;
the reactive power control part comprises:
conducting power closed-loop through a reactive power PID controller of the grid-connected point; and
distributing the reactive power target value to the power conversion system, and distributing the reactive power target value to the photovoltaic controller.

20. The photovoltaic system for industrial and commercial use according to claim 13, wherein in distributing the real power target value to the power conversion system, in the case of a plurality of power conversion systems, a state of charge equalization control scheme is activated.
